(19) United States
(12) Patent Application Publication
(10) Pub. No.: US 2004/0105923 A1
(43) Pub. Date: Jun. 3, 2004

(54) Beverage

(75) Inventor: John O'Connell, Bedford (GB)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/722,783

(22) Filed: Nov. 26, 2003

(30) Foreign Application Priority Data
Nov. 29, 2002 (EP) 02258270.4

(51) Int. Cl. C12G 1/06

(52) U.S. Cl. 426/477; 426/569

(57) ABSTRACT

A beverage product comprises a container holding a liquid beverage component and sufficient nitrogen gas to give a gas pressure in the head space of at least about 3.3 bar at 5° C., said liquid beverage comprising an organoleptically acceptable foam-maintaining system such that when the liquid beverage is poured from the container a foam is generated, the volume of which is maintained at greater than about 80% of its initial volume for a period of at least about 10, preferably at least about 30 minutes. The initial volume of the foam may be less than about 20% of the volume of the liquid beverage. The foam-maintaining system may comprise octenylsuccinic acid modified starch, and at least one surface active agent selected from the group consisting of acyl lactylate salts, proteins, protein hydrolysates, sucrose esters, and mixtures thereof.

The present invention relates to beverage products and in particular of foaming beverage products.

There are many examples of foaming beverages which are produced by the use of inserts inside a pressurised can. In the United Kingdom many canned beers, stouts and lagers are sold in cans which contain a so-called “widget” which operates after the can is opened to give a head on the drink which is said to be comparable to the head produced on draught drinks dispensed in EP-A-360284, EP-A-577284, U.S. Pat. No. 4,996,823, U.S. Pat. No. 5,009,901, WO-A-9324384, WO-A-9504689. Examples of non-alcoholic pressurised beverages which are pressurised with nitrous oxide and/or carbon dioxide are described in U.S. Pat. No. 6,403,137 and GB-A-2299978. Beverages that are packaged in a closed container in the presence of carbon dioxide or nitrous oxide and nitrogen are described in EP-A-745329 and EP-A-1034703. Foaming cappuccino coffee products can be made by adding to the coffee drink a creamer comprising protein, lipid and carrier and optionally a modified starch emulsifier or a surfactant as is described in U.S. Pat. No. 6,168,819. Effervescent beverages which are intended to be dispensed directly into the mouth of the consumer are described in WO-A-02070371 and WO-A-02070372.

A first aspect of the present invention provides a beverage product comprising a container holding a liquid beverage component and sufficient nitrogen gas to give a gas pressure in the head space of at least about 3.3 bar at 5° C., said liquid beverage comprising an organoleptically acceptable foam-maintaining system such that when the liquid beverage is poured from the container a foam is generated, the volume of which is maintained at greater than about 80% of its initial volume for a period of at least about 10, preferably at least about 30 minutes.

Preferably, the initial volume of the foam is less than about 20% of the volume of the liquid beverage.

The container should be of sufficient strength that it can hold the pressure of the nitrogen gas inside it and should be impermeable to nitrogen gas. The container may be made of metal e.g., aluminium or steel, a plastic material for example polyethylene terephthalate or glass. The pressure of the gas in the head space within the container should preferably be in the range about 3.3 to about 6 bar at 5° C. The nitrogen gas may be introduced into the container in the form of liquid nitrogen. The term “nitrogen gas” as used herein is intended to include pure nitrogen gas or gas mixtures that are predominantly comprised of nitrogen. Preferably the nitrogen gas has purity of greater than about 97%.

The liquid beverage component may be any consumable liquid. Examples of suitable liquids include optionally flavoured water, optionally flavoured milk, fruit flavoured liquids, tea or tea flavoured liquids, coffee or coffee flavoured liquids, chocolate, chocolate flavoured liquids, fruit smoothies or alcoholic or alcohol-free drinks such as cream liqueurs or cocktails.

In a preferred embodiment, the foam-maintaining system of the liquid beverage comprises octenylsuccinic acid modified starch, and at least one surface active agent selected from the group consisting of acyl lactylate salts, proteins, protein hydrolysates and sucrose esters and mixtures thereof.

The octenylsuccinic acid modified starch may be prepared by forming a covalent complex of a hydrophilic waxy maize starch with an octenylsuccinic acid moiety preferably its anhydride. The production of the octenylsuccinic acid modified starch is shown in the reaction scheme below.

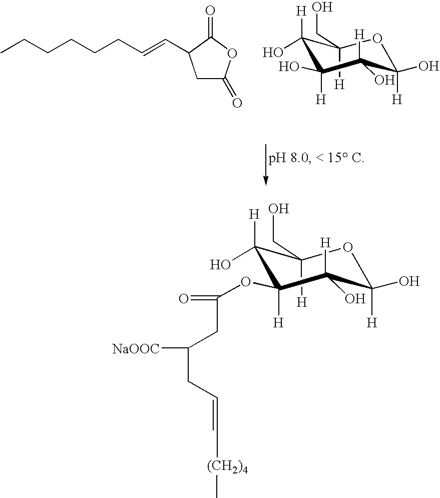

Preferably the octenylsuccinic acid is a carboxy substituted undecenoic acid of formula

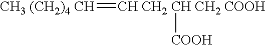

ie 3-carboxy-undec-5-enoic acid

The percentage molar substitution of octenylsuccinic acid groups may be in the range of about 1.9 to about 3%, preferably about 2.2%. The molecular weight of the octenylsuccinic acid modified starch is preferably in excess of about 100,000 kDa.

The octenylsuccinic acid modified starch preferably comprises about 0.25 to about 3.0% more preferably about 0.75 to about 1.5% by weight of the liquid beverage component. Suitable octenylsuccinate acid modified starch include those available from National Starch under the trade names Purity 2000, Purity 1773, Purity 539 and N-Creamer 46. A particularly preferred octenylsuccinic acid modified starch is available commercially from National Starch under the trade name N-Creamer 46

The viscosity of the liquid beverage component is preferably in the order of about 1.5 to about 100 mPa·s⁻¹, more preferably about 30 to about 60 mPa·s⁻¹ under low shear conditions (0.15 s⁻¹) at 5° C.

The acyl lactylate salt preferably comprises an acyl moiety containing 8 to 16 preferably 10 to 14 more preferably around 12 carbon atoms. The acyl lactylate salt may be a sodium or calcium salt. Preferred acyl lactylate salts include calcium stearoyl lactylate and sodium stearoyl lactylate and mixtures thereof. The acyl lactylate salt preferably comprises about 0.005 to about 1%, more preferably about 0.01 to about 0.5% by weight of the liquid beverage.

Suitable proteins and protein hydrolysates are those contained in or derived from milk for example caseinate salts such as sodium caseinate, whey protein isolates or milk protein hydrolysates. The protein and/or protein hydrolysate preferably comprises about 0.01 to about 0.5%, more preferably about 0.1 to about 0.3% by weight of the liquid beverage.

Sucrose esters are esters prepared from sucrose and fatty acids derived from edible fats and oils. Preferred sucrose esters are predominantly monoesters. The fatty acid moiety preferably contains 8 to 16 carbon atoms. Suitable fatty acids include caprylic acid, lauric acid, myristic acid, palmitic acid, stearic acid and mixtures thereof. Suitable sucrose esters are commercially available from Ryoto under the trade names P-1570 (70% monoester with fatty acids derived from vegetable oils containing 70% palmitic acid) and M-1695 (80% monoester with fatty acids derived from vegetable oils containing 95% myristic acid). The sucrose ester preferably comprises about 0.02 to about 0.4%, more preferably about 0.05 to about 0.3% of the liquid beverage.

In preferred beverage products of the present invention the surface active agent comprises an acyl lactylate salt either alone or in combination with a sucrose ester, a protein or a protein hydrolysate.

The surface tension of the liquid beverage component should be in the order of about 65 to about 20 N·m², more preferably about 40 to about 20 N·m².

The beverages of the present invention may contain additional constituents. Examples of suitable additional constituents include:—

(a) sweeteners for example natural sweeteners such as sugars (glucose, fructose, sucrose or corn syrup) or artificial sweeteners such as saccharin, aspartame or acesulfam.

(b) Preservatives for example benzoate or sorbate salts

(c) Antioxidants for example ascorbic acid or salts thereof or tocopherols

(d) Flavour enhancers for example maltol

(e) Flavourings for example fruit flavours or vanilla

(f) pH adjusting agents for example sodium bicarbonate

(g) viscosity adjusting agents for example propylene glycol alginate, carboxymethyl cellulose, high methoxy pectin and/or gums such as guar gum

A second aspect of the present invention provides a method of making a beverage product comprising a container holding a liquid beverage component and nitrogen gas, said liquid beverage comprising an organoleptically acceptable foam-maintaining system, said method comprising the steps of:—

incorporating the organoleptically acceptable foam-maintaining system into the liquid beverage,

placing the liquid beverage into the container,

adding sufficient liquid nitrogen to about 6 bar at 5° C. in the container after sealing, and

sealing the container.

A third aspect of the present invention provides a method of making a beverage product comprising a container holding a liquid beverage component and nitrogen gas, said liquid beverage comprising octenylsuccinic acid modified starch, and at least one surface active agent selected from the group consisting of acyl lactylate salts, proteins, protein hydrolysates and sucrose esters and mixtures thereof, said method comprising the steps of:—

incorporating the octenylsuccinic acid modified starch and the at least one surface active agent into the liquid beverage,

placing the liquid beverage into the container,

adding sufficient liquid nitrogen to the container to provide a head space pressure of about 3.3 to about 6 bar at 5° C. in the container after sealing, and

sealing the container.

The contents of the sealed container may be sterilised after sealing by the application of heat for example by pasteurisation or retorting. Alternatively the product may be subjected to microfiltration or may be filled aseptically.

The present invention provides a beverage which is retained under pressure inside the container before the container is opened but when the nitrogen becomes supersaturated after the container is opened, comes out of solution and forms a stable foam on top of the liquid beverage. In the beverage products of the present invention no widget is required to achieve this. The presence of the foam on top of the dispensed liquid beverage provides a pleasant drinking experience (eg a pleasant taste and creamy mouthfeel) to the consumer as the beverage is consumed. The product may be consumed straight from the container but is preferably poured into a drinking vessel for example a glass before consumption.

The invention will be illustrated by the following non-limiting examples

### EXAMPLE 1

A milked tea beverage was made as described below.

1) Black tea leaf tea (0.6 kg) was extracted with water (18L) at 90±1° C. for 3 minutes. The infusion was then passed through a 20 mesh screen, followed by a 150 mesh screen and cooled to 20-30° C. The infusion was then clarified using a centrifuge.

2) Sugar (5.5 kg) was dissolved in hot water (6L), sterilised by UV treatment and added to the tea extract.

3) UHT-treated skimmed milk (10.6 kg) was added to the resulting mixture

4) Sodium ascorbate (0.05 kg) was dissolved in water (2L) and the solution added to the mixture.

5) Water was added to a volume of 100L

6) The mixture was homogenised at 60-70° C. @ 200 kgf·cm⁻² and heated to 85° C.

7) Skimmed milk powder (1.106 kg) was added and mixed at 13,500 rpm for 2 minutes.

8) Sodium stearoyl lactylate (0.5 kg) was added and mixed at 13,500 rpm for 2 minutes

9) N-Creamer 46 modified starch (1 kg—ex National Starch) was added and mixed at 13,500 rpm for 2 minutes at 65° C.

10) The resulting solution was cooled to 10° C. and maltol (0.03 kg) was added The mixture (<295 ml) was filled into standard 330 ml beverage cans and sufficient liquid nitrogen was injected into the cans to give a head space pressure of 3.5±0.2 bar at 5° C. The cans were then rapidly sealed.

11) The sealed cans were then retorted at 140° C. for 5 minutes

The resulting beverage contained the following constituents

| Constituent | Amount |
|---|---|
| Water | to 100% |
| UHT milk | 10.60% |
| Granulated sugar | 5.5% |
| Tea solids | 0.2% |
| Skimmed milk powder | 1.16% |
| Tea flavour mix 06 | 0.16% |
| Sodium ascorbate | 0.05% |
| Maltol | 0.03% |
| N-Creamer 46 | 1.0% |
| Sodium stearoyl lactylate | 0.5% |

### EXAMPLE 2

A tea beverage was made as described below.

(1) Leaf tea (0.65 kg) was extracted with water (90L) at 90±1° C. for 5 min. The infusion was then passed through 4 layers of muslin cloth and the temperature was held at 70° C.

(2) Sodium bicarbonate (0.01 kg) was dissolved in the filtered infusion

(3) Sugar (3.9 kg) was dissolved in the infusion at 70° C. by stirring gently for 1 minute.

(4) Caramel (0.1 kg) was added to the infusion at 70° C.

(5) Sodium stearoyl lactylate (0.5 kg) added and mixed at 13,500 rpm for 2 minutes

(6) N-Creamer 46 starch (1 kg) added and mixed at 13,500 rpm for 2 minutes at 65° C.

(7) The resulting solution was cooled to 10° C.

(8) Maltol (0.03 kg) was added

(9) Sodium ascorbate (0.05 kg) was dissolved in water (2L) and added to the mixture

(10) Tea aroma concentrate (2 kg) was added and the mixture was made up to 1001 with water.

(11) The beverage mixture (<295 ml) was filled into standard 330 ml aluminium cans

(12) Liquid nitrogen was injected in order to give a head space pressure of 3.5±0.2 bar at 5° C. and the cans were sealed rapidly.

(13) The mixture was then retorted at 140° C. for 5 minutes.

The resulting beverage contained the following constituents

| Constituents | Amount |
|---|---|
| Water | to 100% |
| Tea solids | 0.21% |
| Sugar | 3.9% |
| Tea aroma concentrate | 2.0% |
| Sodium ascorbate | 0.05% |
| Sodium bicarbonate | 0.01% |
| N-creamer 46 | 1.0% |
| Sodium stearoyl lactylate | 0.5% |
| Maltol | 0.03% |
| Caramel | 0.1% |

### EXAMPLE 3

An Irish coffee-type beverage was made as described below.

(1) Water (81.2 kg) was heated to 75° C.

(2) Sugar (3.5 kg) was added and completely dissolved at 70° C.

(3) A mixture of sodium stearoyl lactylate (0.05 kg), calcium stearoyl lactylate (0.05 kg) and sucrose monoesters (0.2 kg) was added and mixed at 13,500 rpm at 70° C.

(4) Skim milk powder (1.0 kg) was added and mixed at 13,500 rpm at 70° C.

(5) N-Creamer 46 (1.0 kg) was added and mixed at 13,500 rpm at 70° C.

(6) Instant coffee powder (0.8 kg) was added and dissolved at 60° C.

(7) The mixture was cooled to ambient temperature and whiskey (12.2 kg) was added

(8) The beverage (<295 ml) was placed in a standard aluminium can (330 ml) and sufficient liquid nitrogen was added to give a head pressure of 3.5±0.2 bar at 5° C. and can was sealed rapidly. Note. The product was filled and nitrogenated under aseptic conditions.

The resulting beverage contained the following constituents

| Constituent | Amount |
|---|---|
| water | to 100% |
| sugar | 3.50% |
| Sodium stearoyl lactylate | 0.05% |
| Calcium stearoyl lactylate | 0.05% |
| Sucrose monoesters | 0.20% |
| Skimmed milk powder | 1.0% |
| N-creamer 46 | 1.0% |
| coffee | 0.80% |
| whiskey | 12.20% |

### EXAMPLE 4

A raspberry flavoured smoothie type beverage was made as described below.

(1) Water (90 kg) is heated to 75 C

(2) Sugar (4 kg) is added and completely dissolved at 70° C.

(3) Sodium stearoyl lactylate (0.5 kg) is added and mixed at 13,500 rpm at 70° C.

(4) Skim milk powder (1 kg) is added and mixed at 13,500 rpm at 70° C.

(5) N-Creamer 46 (1 kg) is added and mixed at 13,500 rpm at 70° C.

(6) pH of solution is increased to pH 7.0 using 1.0M NaOH

(7) Cooled to ambient temperature and raspberry juice (10 kg) is added. The pH of the solution is maintained at pH 6.5 with the addition of 11.0M NaOH

(8) The beverage (<295 ml) was placed in a standard aluminium can (330 mL).

(9) Sufficient liquid nitrogen was added to give a head pressure of 4 bar at 5° C. and the can was sealed rapidly.

(10) The can was retorted at 121° C. for 5 min.

The resulting beverage contained the following constituents

| Constituent | Amount |
|---|---|
| Water | to 100% |
| Raspberry juice | 10% |
| Sugar | 4% |
| N-creamer 46 | 1% |
| Sodium stearyl lactylate | 0.5% |
| Skim milk powder | 1% |
| Vanilla | 0.05% |

### EXAMPLE 5

A milked tea beverage was made as described below.

(1) Black tea leaf tea (0.6 kg) was extracted with water (80L) at 90±1° C. for 3 minutes. The infusion was then passed through a 20 mesh screen, followed by a 150 mesh screen and cooled to 20-30° C. The infusion was then clarified using a centrifuge.

(2) Sugar (5.5 kg) was dissolved in hot water (6L), sterilised by UV treatment and added to the tea extract.

(3) UHT-treated skimmed milk (10.6 kg) was added to the resulting mixture

(4) Sodium ascorbate (0.05 kg) was dissolved in water (2L) and the solution added to the mixture. (5) Water was added to a volume of 90L

(6) The mixture was homogenised at 60-70° C. at 19.6 kPa. [200 kgf·cm⁻²] and heated to 85° C.

(7) Skimmed milk powder (1 kg) was added and mixed at 13,500 rpm for 2 minutes.

(8) Sodium stearoyl lactylate (0.06 kg) was added and mixed at 13,500 rpm for 2 minutes

(9) N-Creamer 46 modified starch (1.25 kg—ex National Starch) was added and mixed at 13,500 rpm for 2 minutes at 65° C.

(10) 0.2 kg of milk protein hydrolysate (Hyfoama, ex. Quest) and dissolved thoroughly at 65° C.

(11) The resulting solution was cooled to 10° C. and maltol (0.03 kg) was added.

(12) The solution was made to 100L with water.

(13) The mixture (<295 ml) was filled into standard 330 ml beverage cans and sufficient liquid nitrogen was injected into the cans to give a head space pressure of 3.5±0.2 bar at 5° C. The cans were then rapidly sealed.

(14) The sealed cans were then retorted at 140° C. for 5 minutes

The resulting beverage contained the following constituents

| Constituent | % solids |
|---|---|
| Water | to 100% |
| UHT milk | 10.60% |
| Granulated sugar | 5.5% |
| Sucrose esters (P1570) | 0.1% |
| Hydrolysed milk protein | 0.2% |
| (Hyfoama DS, Quest) | |
| Tea solids | 0.2% |
| Skimmed milk powder | 1% |
| Tea flavour mix 06 | 0.16% |
| Sodium ascorbate | 0.05% |
| Maltol | 0.03% |
| N-Creamer 46 | 1.25% |
| Sodium stearoyl lactylate | 0.06% |

### COMPARATIVE EXAMPLES A AND B

In a similar way to that described above in Example 3, samples of beverages which had the same constituents as Example 3 were prepared except that Comparative Example A did not contain any surface active agents and comparative Example B did not contain any octenylsuccinic acid modified starch. The products were stored at 5° C. for 3 hours and were then opened and poured into a graduated glass vessel. The amount of foam generated as the beverage was poured was determined from the graduations on the glass vessel. The amount of foam expressed as a percentage of the volume of foam present immediately after pouring was determined periodically for the beverage of Example 3 and for both of the Comparative Examples A and B. The results are shown in the Table below

| | Example 3 | Example A | Example B |
|---|---|---|---|
| Foam volume | 6.34% | 6.66% | 7.93% |
| Time (minutes) | Foam volume as % of volume at t₀ | | |
| 2.5 | 100 | 100 | 100 |
| 5 | 100 | 75 | 100 |
| 10 | 100 | 50 | 60 |
| 15 | 100 | 50 | 44 |
| 20 | 100 | 50 | 20 |
| 30 | 95 | 40 | 20 |
| 40 | 90 | 35 | 12 |
| 60 | 90 | 25 | 8 |

From the table it can be seen that the foam generated from Example 3 lasts considerably longer than the foam generated from either of the Comparative Examples.

1) A beverage product comprising a container holding a liquid beverage component and sufficient nitrogen gas to give a gas pressure in the head space of at least about 3.3 bar at 5° C., said liquid beverage comprising an organoleptically acceptable foam-maintaining system such that when the liquid beverage is poured from the container a foam is generated, the volume of which is maintained at greater than about 80% of its initial volume for a period of at least about 10 minutes.

2) A beverage product as claimed in claim 1 wherein the volume of the foam is maintained at greater than about 80% of its initial volume for a period of at least about 30 minutes.

3) A beverage product as claimed in claim 1 wherein the initial volume of the foam is less than about 20% of the volume of the liquid beverage.

4) A beverage product as claimed in claim 1 wherein the pressure of nitrogen in the head space of the container is in the range about 3.3 to about 6 bar at 5° C.

5) A beverage product as claimed in claim 1 wherein the foam maintaining system of the liquid beverage comprising octenylsuccinic acid modified starch, and at least one surface active agent selected from the group consisting of acyl lactylate salts, proteins, protein hydrolysates and sucrose esters and mixtures thereof.

6) A beverage product as claimed in claim 5 wherein the octenylsuccinic acid modified starch is prepared by forming a covalent complex of a hydrophilic waxy maize starch with an octenylsuccinic acid moiety

7) A beverage product as claimed in claim 5 wherein the octenylsuccinic acid is a carboxy substituted undecenoic acid of formula

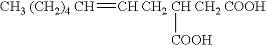

8) A beverage product as claimed in claim 5 wherein the percentage molar substitution of octenylsuccinic acid groups in the range of about 1.9 to about 3%.

9) A beverage product as claimed in claim 5 wherein percentage molar substitution of octenylsuccinic acid groups is about 2.2%.

10) A beverage product as claimed in claim 5 wherein molecular weight of the octenylsuccinic acid modified starch is in excess of about 100,000 kDa.

11) A beverage product as claimed in claim 5 wherein the octenylsuccinic acid modified starch comprises about 0.25 to about 3.0% by weight of the liquid beverage component.

12) A beverage product as claimed in claim 5 wherein the octenylsuccinic acid modified starch comprises about 0.75 to about 1.5% by weight of the liquid beverage component.

13) A beverage product as claimed in claim 5 wherein the acyl lactylate salt comprises an acyl moiety containing 8 to 16 carbon atoms.

14) A beverage product as claimed in claim 13 wherein the acyl moiety of the acyl lactylate salt contains 10 to 14 carbon atoms.

15) A beverage product as claimed in claim 13 wherein the acyl moiety of the acyl lactylate salt contains around 12 carbon atoms.

16) A beverage product as claimed in claim 5 wherein the acyl lactylate salt is a sodium or calcium salt

17) A beverage product as claimed in claim 5 wherein the acyl lactylate salt is calcium stearoyl lactylate, sodium stearoyl lactylate or mixtures thereof.

18) A beverage product as claimed in claim 5 wherein the acyl lactylate salt comprises about 0.005 to about 1% by weight of the liquid beverage.

19) A beverage product as claimed in claim 5 wherein the acyl lactylate salt comprises about 0.01 to about 0.5% by weight of the liquid beverage.

20) A beverage product as claimed in claim 5 wherein the proteins and protein hydrolysates are those contained in or derived from milk

21) A beverage product as claimed in claim 5 wherein the proteins and protein hydrolysates are selected from sodium caseinate, whey protein isolates or milk protein hydrolysates

22) A beverage product as claimed in claim 5 wherein the sucrose ester is predominantly a monoester.

23) A beverage product as claimed in claim 5 wherein the sucrose ester is prepared from sucrose and fatty acids derived from edible fats and oils, said fatty acids containing 8 to 16 carbon atoms

24) A beverage product as claimed in claim 23 wherein the fatty acid is caprylic acid, lauric acid, myristic acid, palmitic acid, stearic acid or mixtures thereof

25) A beverage product as claimed in claim 5 wherein the sucrose ester comprises about 0.02 to about 0.4% by weight of the liquid beverage.

26) A beverage product as claimed in claim 5 wherein the sucrose ester comprises about 0.05 to about 0.3% by weight of the liquid beverage.

27) A method of making a beverage product comprising a container holding a liquid beverage component and nitrogen gas, said liquid beverage comprising an organoleptically acceptable foam-maintaining system, said method comprising the steps of:—
incorporating the organoleptically acceptable foam-maintaining system into the liquid beverage,
placing the liquid beverage into the container,
adding sufficient liquid ntrogen to the container to provide a head space pressure of about 3.3 to about 6 bar at 5° C. in the container after sealing, and
sealing the container.

28) A method of making a beverage product comprising a container holding a liquid beverage component and nitrogen gas, said liquid beverage comprising octenylsuccinic acid modified starch, and at least one surface active agent selected from the group consisting of acyl lactylate salts, proteins, protein hydrolysates and sucrose esters and mixtures thereof, said method comprising the steps of:—
incorporating the octenylsuccinic acid modified starch and the at least one surface active agent into the liquid beverage,
placing the liquid beverage into the container,
adding sufficient liquid nitrogen to the container to provide a head space pressure of about 3.3 to about 6 bar at 5° C. in the container after sealing, and
sealing the container.
